(19) United States
(12) Patent Application Publication
(10) Pub. No.: US 2026/0262012 A1
(43) Pub. Date: Sep. 3, 2026

(54) METHOD FOR MSG3 REPETITION REQUEST IN A NON-TERRESTRIAL NETWORK (NTN)

(71) Applicant: Nokia Technologies Oy, Espoo (FI)

(72) Inventors: Amir Mehdi AHMADIAN TEHRANI, Munich (DE); Alessio MARCONE, Munich (DE); Frank FREDERIKSEN, Aalborg (DK)

(21) Appl. No.: 19/045,776

(22) PCT Filed: Jul. 14, 2023
(86) PCT No.: PCT/EP2023/069603

§ 371 Date: Feb. 5, 2025

(30) Foreign Application Priority Data
Aug. 5, 2022 (FI) 20225702

(51) Int. Cl. H04W 64/00; H04W 72/02; H04W 74/0833; H04W 84/06

(52) U.S. Cl. CPC H04W 64/003; H04W 72/02; H04W 74/0833; H04W 84/06

(57) ABSTRACT

Various techniques are provided for receiving, by a user equipment (UE), a Msg3 repetition request configuration set including a set of resources for Msg1 transmission, determining, by the UE, a metric associated with a position of a non-terrestrial network (NTN) satellite with respect to the UE, determining, by the UE, a subset of the set of resources for Msg1 transmission based on the metric, determining, by the UE, whether a repetition request applies, and in response to determining the repetition request applies, selecting, by the UE, a resource from the subset of the set of resources for Msg1 transmission.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process to meet the requirements of 5G, similar to earlier evolution of 3G & 4G wireless networks. 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency.

### SUMMARY

According to an example embodiment, a device, a system, a non-transitory computer-readable medium (having stored thereon computer executable program code which can be executed on a computer system), and/or a method can perform a process including determining a control resource set (CORESET) frequency location from a punctured synchronization signal block according to an example embodiment. A method may include receiving, by a user equipment (UE), a Msg3 repetition request configuration set including a set of resources for Msg1 transmission, determining, by the UE, a metric associated with a position of a non-terrestrial network (NTN) satellite with respect to the UE, determining, by the UE, a subset of the set of resources for Msg1 transmission based on the metric, determining, by the UE, whether a repetition request applies, and in response to determining the repetition request applies, selecting, by the UE, a resource from the subset of the set of resources for Msg1 transmission.

Implementations can include one or more of the following features. For example, the method can further include transmitting Msg1 based on the selected resource. The Msg3 repetition request configuration set can further include a mapping between a range of the metric and a subset of the set of resources for Msg1 transmission. The resources can be preambles or random access channel occasions. The metric can be a distance to the NTN satellite from the UE, or an elevation angle of the NTN satellite detected at the UE. The determining of the distance to the NTN satellite can include calculating the elevation angle of the NTN satellite and calculating the distance to the NTN satellite based on the elevation angle. The distance to the NTN satellite is calculated as

$$d = {R}_{e} [ \sqrt{{( \frac{h + {R}_{e}}{{R}_{e}} )}^{2}} - c o {s}^{2} φ - sin φ ] ,$$

where d is the distance to the NTN satellite, Rₑ is the radius of the Earth, h is the NTN satellite altitude, and φ is the UE elevation angle. The method can further include in response to determining the repetition request does not apply, the UE does not make a Msg3 repetition request. The determining whether the repetition request applies can be based on an SSB RSRP threshold. The UE is a coverage enhanced (CE) UE.

According to an example embodiment, a device, a system, a non-transitory computer-readable medium (having stored thereon computer executable program code which can be executed on a computer system), and/or a method can perform a process including determining a control resource set (CORESET) frequency location from a punctured synchronization signal block according to an example embodiment. A method may include configuring, by a base station, a set of resources for Msg1 transmission, mapping, by the base station, the set of resources for Msg1 transmission to a range associated with a metric associated with a position of the base station with respect to a user equipment (UE), the base station being included in a non-terrestrial network (NTN) satellite, generating, by the base station, a Msg3 repetition request configuration set based on the set of resources for Msg1 transmission and the mapped range, and communicating, by the base station to the UE, the Msg3 repetition request configuration set.

Implementations can include one or more of the following features. For example, the metric can be a distance to the NTN satellite from the UE, or an elevation angle of the NTN satellite detected at the UE. The resources can be preambles or random access channel occasions. The preambles can include at least one physical random access channel (PRACH) preamble sequence. Each set of resources for Msg1 transmission can be associated with a geographic portion of a cell. The UE can be a first UE, the method can further include detecting, by the base station, a second UE, in response to detecting the second UE, revising, by the base station, the Msg3 repetition request configuration set, and communicating, by the base station to the UE, the revised Msg3 repetition request configuration set. The higher-layer signaling can be communicated using higher-layer signaling.

The details of one or more examples of embodiments are set forth in the accompanying drawings and the description below. Other features will be apparent from the description and drawings, and from the claims.

### BRIEF DESCRIPTION OF THE DRAWINGS

FIGS. 1A and 1B are block diagrams of a wireless network according to an example embodiment.

FIG. 2 is a flow diagram illustrating Msg 3 repetition configuration according to an example embodiment.

FIG. 3 is an illustration of a non-terrestrial network (NTN) according to an example embodiment.

FIG. 4 is an illustration of a satellite geometry according to an example embodiment.

FIG. 5 is a block diagram of a method of operating a user equipment according to an example embodiment.

FIG. 6 is a block diagram of a method of operating a NTN base station according to an example embodiment.

FIG. 7 is a block diagram of a wireless station or wireless node (e.g., AP, BS, gNB, RAN node, relay node, UE or user device, network node, network entity, DU, CU-CP, CU-CP, . . . or other node) according to an example embodiment.

### DETAILED DESCRIPTION

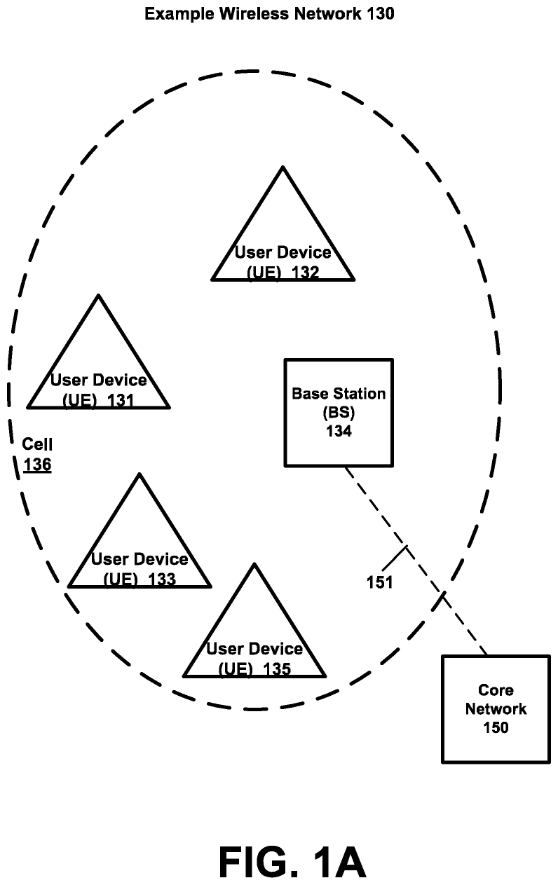

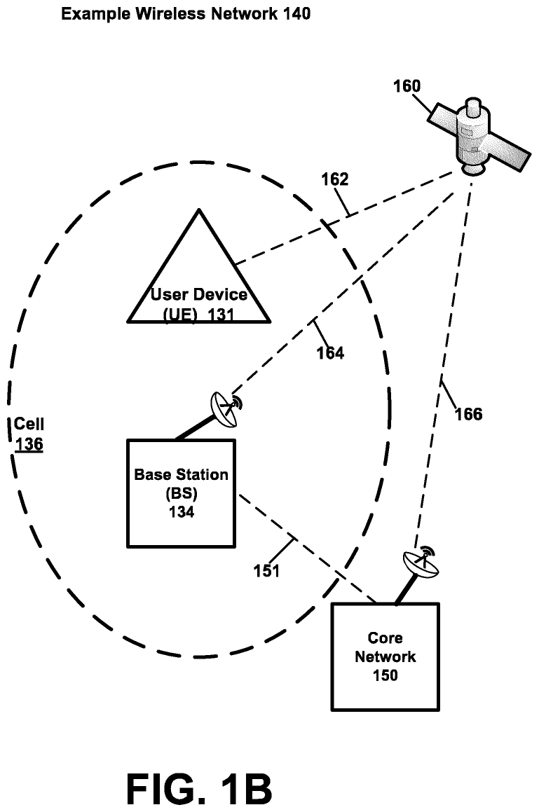

FIG. 1A is a block diagram of a wireless network 130 according to an example embodiment. FIG. 1B is a block diagram of a wireless network 140 according to an example embodiment. In the wireless network 130 of FIG. 1A and/or the wireless network 140 of FIG. 1B, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a BS, next generation Node B (gNB), a next generation enhanced Node B (ng-eNB), or a network node. The terms user device and user equipment (UE) may be used interchangeably.

The BS 134 can be referred to as a terrestrial BS. The wireless network 140 can extent the wireless network 130 to further include a non-terrestrial network (NTN) base station (NTN-BS) 160. NTN-BS 160 can be implemented in a low-earth orbit (LEO) satellite, a medium-earth orbit (MEO) satellite, a geostationary earth orbit (GEO) satellite, a high elliptical orbit (HEO) satellite, an unmanned aircraft system (UAS), a lighter than air (LTA) UAS, a heavier than air (HTA) UAS, and/or the like. Further, the NTN-BS can be on the ground with the signals being routed through the satellite.

A BS (including a NTN-BS) may also include or may be referred to as a RAN (radio access network) node, and may include a portion of a BS or a portion of a RAN node, such as (e.g., such as a centralized unit (CU) and/or a distributed unit (DU) in the case of a split BS). At least part of the functionalities of a BS (e.g., access point (AP), base station (BS), NTN base station (NTN-BS), or (e)Node B (eNB), BS, RAN node) may also be carried out by any node, server or host which may be operably coupled to a transceiver, such as a remote radio head or satellite. BS (or AP) 134 provides wireless coverage within a cell 136, including to user devices (or UEs) 131, 132, 133 and 135. NTN-BS 160 can provide wireless coverage within a cell 136, within a plurality of cells (not shown) and/or within a geographic coverage area. Although only four user devices (or UEs) are shown as being connected or attached to BS 134 and/or NTN-BS 160, any number of user devices may be provided. BS 134 and is also connected to a core network 150 via a S1 interface or NG interface 151. NTN-BS 160 is also connected to the UEs (shown as UE 131) via a Uu interface 162. NTN-BS 160 is also connected to the BS 134 via a SING interface 164. NTN-BS 160 is also connected to core network 150 via a S1 interface or NG interface 166. These are merely one simple example of a wireless network, and others may be used.

A base station (e.g., such as BS 134 and/or NTN-BS 160) is an example of a radio access network (RAN) node within a wireless network. A BS (or a RAN node) may be or may include (or may alternatively be referred to as), e.g., an access point (AP), a gNB, an eNB, or portion thereof (such as a centralized unit (CU) and/or a distributed unit (DU) in the case of a split BS or split gNB), or other network node. For example, a BS (or gNB) may include: a distributed unit (DU) network entity, such as a gNB-distributed unit (gNB-DU), and a centralized unit (CU) that may control multiple DUs. In some cases, for example, the centralized unit (CU) may be split or divided into: a control plane entity, such as a gNB-centralized (or central) unit-control plane (gNB-CU-CP), and an user plane entity, such as a gNB-centralized (or central) unit-user plane (gNB-CU-UP). For example, the CU sub-entities (gNB-CU-CP, gNB-CU-UP) may be provided as different logical entities or different software entities (e.g., as separate or distinct software entities, which communicate), which may be running or provided on the same hardware or server, in the cloud, etc., or may be provided on different hardware, systems or servers, e.g., physically separated or running on different systems, hardware or servers.

As noted, in a split configuration of a gNB/BS, the gNB functionality may be split into a DU and a CU. A distributed unit (DU) may provide or establish wireless communications with one or more UEs. Thus, a DUs may provide one or more cells, and may allow UEs to communicate with and/or establish a connection to the DU in order to receive wireless services, such as allowing the UE to send or receive data. A centralized (or central) unit (CU) may provide control functions and/or data-plane functions for one or more connected DUs, e.g., including control functions such as gNB control of transfer of user data, mobility control, radio access network sharing, positioning, session management etc., except those functions allocated exclusively to the DU. CU may control the operation of DUs (e.g., a CU communicates with one or more DUs) over a front-haul (Fs) interface.

According to an illustrative example, in general, a BS node (e.g., BS, eNB, gNB, CU/DU, . . . ) or a radio access network (RAN) may be part of a mobile telecommunication system. A RAN (radio access network) may include one or more BSs or RAN nodes that implement a radio access technology, e.g., to allow one or more UEs to have access to a network or core network. Thus, for example, the RAN (RAN nodes, such as BSs or gNBs) may reside between one or more user devices or UEs and a core network. According to an example embodiment, each RAN node (e.g., BS, eNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node and sending data to and/or receiving data from one or more of the UEs. For example, after establishing a connection to a UE, a RAN node (e.g., BS, eNB, gNB, CU/DU, . . . ) may forward data to the UE that is received from a network or the core network, and/or forward data received from the UE to the network or core network. RAN nodes (e.g., BS, eNB, gNB, CU/DU, . . . ) may perform a wide variety of other wireless functions or services, e.g., such as broadcasting control information (e.g., such as system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform. A base station may also be DU (Distributed Unit) part of IAB (Integrated Access and Backhaul) node (a.k.a. a relay node). DU facilitates the access link connection(s) for an IAB node.

A user device (user terminal, user equipment (UE), mobile terminal, handheld wireless device, etc.) may refer to a portable computing device that includes wireless mobile communication devices operating either with or without a subscriber identification module (SIM) (which may be referred to as Universal SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. A user device may be also MT (Mobile Termination) part of IAB (Integrated Access and Backhaul) node (a.k.a. a relay node). MT facilitates the backhaul connection for an IAB node.

In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)) may also include a core network (e.g., which may be referred to as 5GC in 5G/NR).

In addition, by way of illustrative example, the various example embodiments or techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), massive MTC (mMTC), Internet of Things (IoT), and/or narrowband IoT (NB-IoT) user devices, enhanced mobile broadband (eMBB), and ultra-reliable and low-latency communications (URLLC). Many of these new 5G (NR)-related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10-5 and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to an eMBB UE (or an eMBB application running on a UE).

The various example embodiments may be applied to a wide variety of wireless technologies or wireless networks, such as LTE, LTE-A, 5G (New Radio (NR)), cmWave, and/or mmWave band networks, IoT, MTC, eMTC, mMTC, eMBB, URLLC, etc., or any other wireless network or wireless technology. These example networks, technologies or data service types are provided only as illustrative examples.

In a Terrestrial Networks (TN) channel conditions can be consistent over large periods of time. By contrast, channel conditions in NTN can change rapidly and in a semi-predictive manner. A base station in a TN can be in a fixed position. By contrast, a base station position in an NTN is not necessarily fixed. Therefore, changes on UE's pathloss, distance and elevation angle during satellite orbit may need to be taken into consideration. Msg3 PUSCH repetition Type A is one such communication channel where changes on UE's pathloss, distance and elevation angle during satellite orbit may need to be taken into consideration.

Msg3 PUSCH repetition Type A can be requested by coverage enhanced (CE) UE during Msg1 PRACH if, for example, a measured SS-RSRPs of all SSBs are below certain threshold as follows:

$$SS - RSRP < rsrp - ThresholdSSB \text{+/-} rsrp - Threshold - Msg 3 Rep , \qquad ( 1 )$$

A new threshold (e.g., rsrp-Threshold-Msg3Rep) can be defined (eqn. 1) for NTN. The new threshold can be configured by the BS which could be greater or lower than rsrp-ThresholdSSB. In coverage enhancement scenario, depending on channel conditions, different number of repetitions are required for each UE to ensure correct reception at the gNB. Apart from configuring a new threshold to distinguish CE UEs from legacy UEs via sending Msg3 repetition request via applying different sets of preambles PRACH/preamble or RACH occasions (dedicated to CE featured UE), the BS can determine the number of repetitions based on, for example, received quality of CE UE transmitted Msg1. The maximum number of Msg3 repetition can be determined based on an enhancement target and scenario context (e.g., BLER expectations with respect to rural, urban, or suburban scenario) to compensate the coverage gap.

The number of CE UEs in a cell requesting Msg3 repetition may be increased as satellite moves towards horizon. Therefore, the probability of meeting the requirements of eqn. (1) for UEs in the cell may be increased. This can lead to more CE UEs communicating a request for Msg3 repetition by selecting PRACH preambles from the same reserved preamble group. If satellite movement is considered, the probability of collision as well as the number of requests may be increased when the satellite moves towards horizon because many more UEs may meet the requirements of eqn. (1) in the cell. These UEs may be making Msg3 request at the same time.

Considering a fixed UE position, the satellite movement itself can cause an increasing number of Msg3 repetition requests due to high signal fluctuation, when passing from the nadir to the horizon. Therefore, there is need to define a solution to optimize the size of the preamble or RACH occasions (RO) set, such that PRACH resources are not too scarce when the satellite is far from Earth and are not too many when the satellite is closer to Earth. Example implementations provide enhancements to the Msg3 repetition request during PRACH in NTN that lower the number of collisions and unsuccessful PRACH and can compensate the dynamics of the channel conditions due to satellite movement and high signal fluctuations.

An example implementation can introduce a dynamic subset of preambles or RO for Msg3 repetition request, derived from the set of preambles or RO configured by the network. For example, a subset size can adapt to satellite position to the Earth and can be mapped to a range of UE distances from the NTN satellite. In the Example implementation, a subset from the set of preambles or RO can be determined with respect to a calculated distance. For example, if the satellite is located above the UE, where the distance is low, a small proportion of repetition preambles or RO may be available for UE selection for PRACH transmission. For example, if the satellite is located far from the UE where the calculated elevation angle (e.g., UE_{φ}) and distance are relatively low and high, respectively, a larger proportion of preambles and RO may be available for UE selection for PRACH transmission. To determine dynamic subset of preambles or RO, Msg3Rep-Preamble set can be configured (e.g., via RRC). In this example, each subset of preambles or RO in Msg3Rep-PreambleSubset can be mapped into a range of UE distances defined by the BS (e.g., NTN-BS). This may depend on the relative position of the UE in the satellite beam covering the UE. Different repetitions factors may be available for UEs being at the edges or the center of the beam, if the beam size is large enough. This can be accounted for by the BS when assigning a specific number of repetitions for Msg3. In an example, the configuration of an Msg3Rep-PreambleSubset distance can be cell-specific and may apply to CE NTN UEs in the cell.

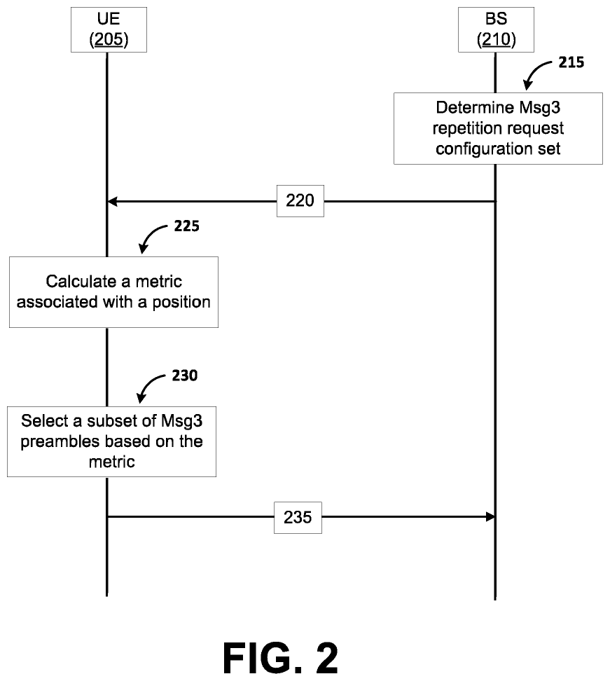

FIG. 2 is a flow diagram illustrating Msg 3 repetition configuration according to an example implementation. As shown in FIG. 2, a wireless system can include a UE 205 and a BS 210. The UE 205 and/or the BS 210 can be configured to communicate (e.g., wirelessly communicate) between each other. For example, the UE 205 and the BS 210 can be configured to communicate messages, signals and/or the like between each other. For example, the UE 205 and/or the BS 210 can be configured to communicate using a wireless standard as described above. In an example implementation, in block 215 the BS 120 can determine Msg3 repetition request configuration set. The Msg3 repetition request configuration set can include a set of resources for Msg1 transmission. The resources can be preambles or random access channel occasions. For example, the Msg3 repetition request configuration set can include a subset number, a distance range and a Msg3 repetition preamble subset range.

The UE 205 can map the N subsets in the Msg3Rep-Preamble set to a range associated with a metric. The metric can be related to the position of the NTN satellite including BS 210 with respect to the UE 205. The UE 205 can map the N subsets in the Msg3Rep-Preamble set to a selected range of distances. For example, Table 1 can illustrate an example Msg3 repetition request configuration set mapped to a respective distance. The BS 210 can change Msg3 repetition request configuration set, the mapping, and/or the respective distance based on a number and/or a change in number of UEs in a cell and/or a zone in the cell. In block 220 the BS 210 communicates a message 220 to the UE 205. The message 220 can include the Msg3 repetition request configuration set. In an example implementation, the UE 205 can communicate message 220 via a higher-layer signalling (e.g., SIB1). The message 220 can be re-communicated when, for example, the Msg3 repetition request configuration set, the mapping, and/or the respective distance changes.

TABLE 1

| Subset# | Distance range | Msg3Rep-PreambleSubSetRange |
|---|---|---|
| 1 | 500 Km < d < 650 Km | PRACH Sequence [1] . . . [5] |
| 2 | 651 Km < d < 800 Km | PRACH Sequence [1] . . . [10] |
| 3 | 801 Km < d < 950 Km | PRACH Sequence [1] . . . [25] |
| . . . | . . . | . . . |
| n | d > 1920 Km | PRACH Sequence [1] . . . [35] |

In response to receiving the message 220, in block 225, the UE 205 can calculate a metric associated with a position. The metric can be a distance to the NTN satellite including the BS 210 from the UE 205, or an elevation angle of the NTN satellite detected at the UE 205. In an example implementation, the elevation angle (e.g., UE_{φ}) can be calculated using, for example, algorithms such as MUSIC and/or ESPRIT. In an example implementation, the distance (d) from UE 205 to BS 210 can be calculated as:

$$d = {R}_{e} [ \sqrt{{( \frac{h + {R}_{e}}{{R}_{e}} )}^{2}} - c o {s}^{2} φ - sin φ ] , \qquad ( 2 )$$

where Rₑ indicates the Earth radius,
h indicates the Satellite Altitude, and
φ indicates the UE elevation angle.
   The calculation of elevation angle and distance between UE 205 and the satellite 205 can be based on the information related to the serving satellite ephemeris (e.g., the satellite's position in space combined with information on the satellite movement) from broadcast information in, for example, SIB19, and the information related to the UEs 205 geo-location from the use of GNSS information (e.g., GPS-like information). The distance calculation can be based on the time the distance is calculated/estimated.

For example, the time that the UE calculates/estimates the distance to the satellite for selection of the preamble can be based on at least one of the transmission time of the random access preamble, an expected reception time of the random access response (e.g., the end of the random access response window), and/or an expected transmission time of the Msg3. The expected transmission time of the Msg3 can be configured by the base station and/or be a hard-coded value at the UE side (e.g., two (2) times the round trip time to the satellite plus a processing delay).

Then, in block 230, the UE 205 can select and/or determine a subset of Msg3 preambles or RO based on the distance. For example, if the UE 205 calculates the distance as 870 Km, referring to Table 1, the UE 205 may select subset number three (3). The UE 205 can perform block 230 (and block 235) after the UE 205 evaluates its UE_{RSRP} as:

$${UE}_{RSRP} < rsrp - ThresholdSSB - rsrp - Threshold - Msg 3 Rep , \qquad ( 3 )$$

If UE_{RSRP} meets the requirements of eqn. (3), the UE 205 may perform block 230 (and block 235). Otherwise, the UE 205 may not communicate message 235 to make Msg3 repetition request.

In block 235 the UE 205 communicates a message 235 to the BS 210. The message 235 can be a Msg3 repetition request communicated using the subset of Msg1 preambles or RO. Continuing the example, the UE 205 may communicate the message 235 using the subset of PRACH preambles, PRACH Sequence [1] . . . [25]. If UE_{RSRP} does not meet the requirements of eqn. (3), the UE 205 may not perform block 230 and the UE 205 may not communicate message 235 to make Msg3 repetition request.

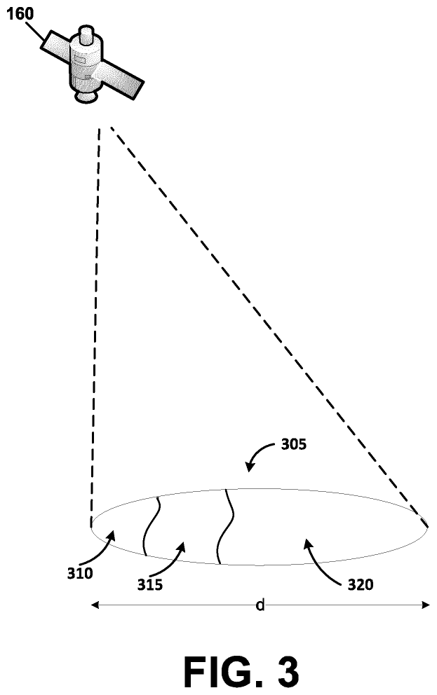

FIG. 3 is an illustration of a non-terrestrial network (NTN) according to an example embodiment. As shown in FIG. 3, the NTN includes the BS 160, a cell 305, and a geographic region 310, 315, 320. In an example implementation the geographic region 310 is associated with a first subset, the geographic region 315 is associated with a second subset, and the geographic region 320 is associated with a third subset. For example, referring to table 1, the first subset can be subset #1, the second subset can be subset #2, and the third subset can be subset #3.

The cell 305 can cover a distance d (e.g., up to 1000 Km). Each geographic region 310, 315, 320 can have a number of UEs (e.g., CE UEs) being served by the BS 160 (e.g., as an NTN-BS). UEs distance to the BS 160 located in the same region are close to each other. In an example implementation, the Msg3 repetition request configuration set can include the first subset, the second subset, and the third subset associated with the geographic region 310, the geographic region 315, and the geographic region 320 respectively. The Msg3 repetition request configuration set can change as the satellite including BS 160 moves (e.g., with the Earth's rotation) and/or the number of UEs in the geographic region 310, 315, 320 changes. A UE within the geographic region 310, 315, 320 can select a subset based on the distance to the satellite including the BS 160 which may be the subset associated with the geographic region 310, 315, 320.

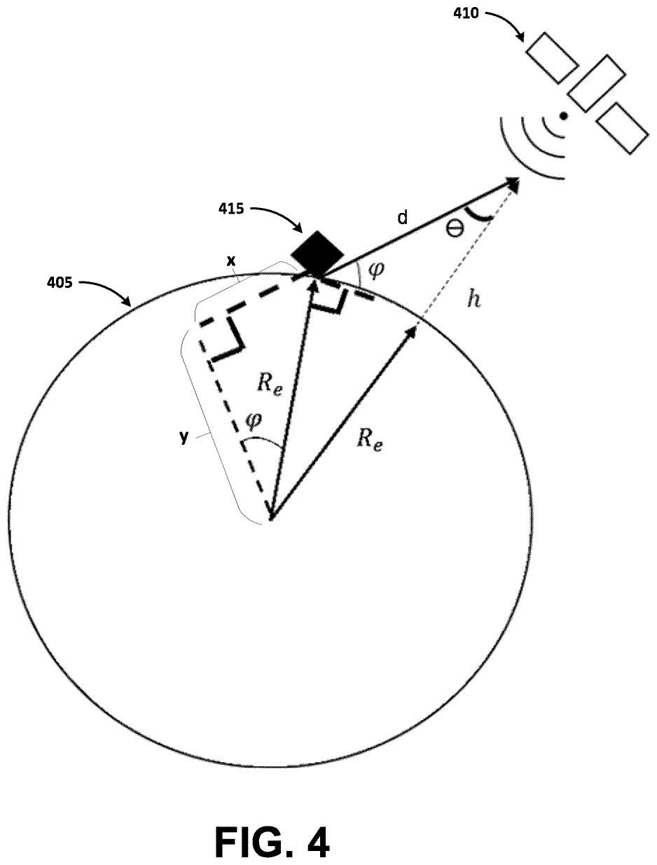

FIG. 4 is an illustration of a satellite geometry according to an example embodiment. As shown in FIG. 4, a circle 405 represents the Earth, a satellite 410 is in the Earth's orbit, and a UE 415 is in a position on the Earth. FIG. 4 can be used to show variables used in eqn. (2) above. As shown in FIG. 4, Rₑ indicates the Earth radius, h indicates the satellite altitude, φ indicates the UE elevation angle, and d represents the distance from the UE 415 to the satellite 410. FIG. 4 can be used to prove eqn. (2) per the below proof.

Initially:

$$cos ( θ ) = \frac{d + x}{Re + h} , \qquad ( 4 )$$

$$sin ( θ ) = \frac{y}{Re + h} , \qquad ( 5 )$$

$$cos ( φ ) = \frac{y}{{Re}^{′}}$$

$$\to y = Re . Cos ( φ ) . x = Re . Sin ( φ )$$

Eqn. (4) and (5) can be rewritten as the following:

$$cos ( θ ) = \frac{d + Re . Sin ( φ )}{Re + h} , \qquad ( 6 )$$

$$sin ( θ ) = \frac{Re . Cos ( φ )}{Re + h} , \qquad ( 7 )$$

Knowing that,

$${sin}^{2} ( θ ) + {cos}^{2} ( θ ) = 1 ,$$

$$\to 1 - {( \frac{Re . Cos ( φ )}{Re + h} )}^{2} = {( \frac{d + Re . Sin ( φ )}{Re + h} )}^{2}$$

Expanding the above equations can result in:

$${d}^{2} = {( Re + h )}^{2} - {Re}^{2} - 2 Re . d . sin ( φ )$$

$${d}^{2} + 2 Re . d . sin ( φ ) + {Re}^{2} {sin}^{2} ( φ ) = {( Re + h )}^{2} - {Re}^{2} ++ {Re}^{2} {sin}^{2} ( φ )$$

$${( d + Re sin ( φ ) )}^{2} = {( Re + h )}^{2} - {Re}^{2} ++ {Re}^{2} {sin}^{2} ( φ )$$

$$d = \sqrt{{( Re + h )}^{2} - {Re}^{2} ++ {Re}^{2} {sin}^{2} ( φ )} - Re sin ( φ )$$

$$d = Re [ \sqrt{{( Re + h )}^{2} / {Re}^{2} - 1 - {sin}^{2} ( φ )} - sin ( φ ) ]$$

$$\to d = Re [ \sqrt{{( Re + h )}^{2} / {Re}^{2} - {cos}^{2} ( φ ) + {sin}^{2} ( φ ) - {sin}^{2} ( φ )} - sin ( φ ) ]$$

$$\to d = Re [ \sqrt{{( Re + h )}^{2} / {Re}^{2} - {cos}^{2} ( φ )} - sin ( φ ) ]$$

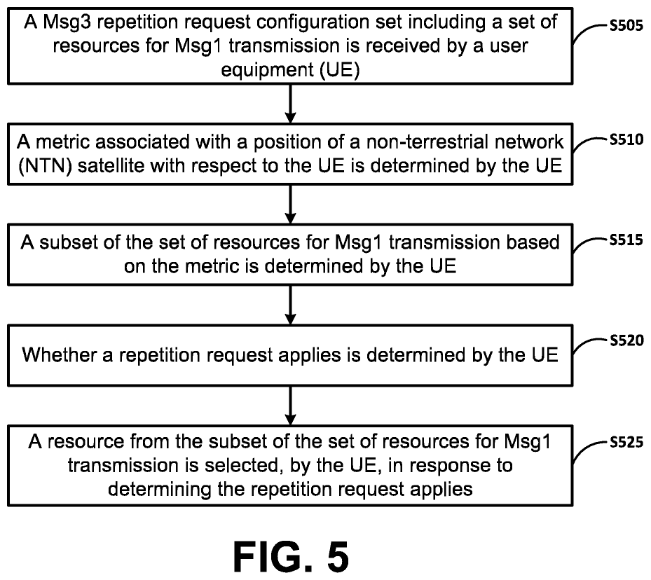

Example 1. FIG. 5 is a block diagram of a method of operating a user equipment according to an example embodiment. As shown in FIG. 5, in step S505 a Msg3 repetition request configuration set including a set of resources for Msg1 transmission is received by a user equipment (UE). In step S510 a metric associated with a position of a non-terrestrial network (NTN) satellite with respect to the UE is determined by the UE. In step S515 a subset of the set of resources for Msg1 transmission based on the metric is determined by the UE. In step S520 whether a repetition request applies is determined by the UE. In step S525 a resource from the subset of the set of resources for Msg1 transmission is selected, by the UE, in response to determining the repetition request applies.

Example 2. The method of Example 1 can further include transmitting Msg1 based on the selected resource.

Example 3. The method of Example 1, wherein the Msg3 repetition request configuration set can further include a mapping between a range of the metric and a subset of the set of resources for Msg1 transmission.

Example 4. The method of Example 1, wherein the resources can be preambles or random access channel occasions.

Example 5. The method of Example 1, wherein the metric can be a distance to the NTN satellite from the UE, or an elevation angle of the NTN satellite detected at the UE.

Example 6. The method of Example 5, wherein the determining of the distance to the NTN satellite can include calculating the elevation angle of the NTN satellite and calculating the distance to the NTN satellite based on the elevation angle.

Example 7. The method of Example 6, wherein the distance to the NTN satellite is calculated as

$$d = {R}_{e} [ \sqrt{{( \frac{h + {R}_{e}}{{R}_{e}} )}^{2}} - c o {s}^{2} φ - sin φ ] ,$$

where d is the distance to the NTN satellite, Rₑ is the radius of the Earth, h is the NTN satellite altitude, and φ is the UE elevation angle.

Example 8. The method of Example 1 can further include in response to determining the repetition request does not apply, the UE does not make a Msg3 repetition request.

Example 9. The method of Example 1, wherein the determining whether the repetition request applies can be based on an SSB RSRP threshold.

Example 10. The method of Example 1, wherein the UE is a coverage enhanced (CE) UE.

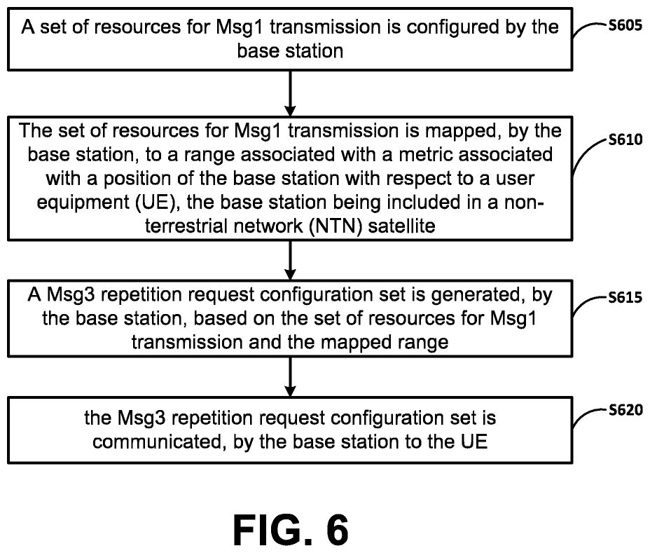

Example 11. FIG. 6 is a block diagram of a method of operating an NTN base station according to an example embodiment. As shown in FIG. 6, in step S605 a set of resources for Msg1 transmission is configured by the base station. In step S610 the set of resources for Msg1 transmission is mapped, by the base station, to a range associated with a metric associated with a position of the base station with respect to a user equipment (UE), the base station being included in a non-terrestrial network (NTN) satellite. In step S615 a Msg3 repetition request configuration set is generated, by the base station, based on the set of resources for Msg1 transmission and the mapped range. In step S620 the Msg3 repetition request configuration set is communicated, by the base station to the UE.

Example 12. The method of Example 11, wherein the metric can be a distance to the NTN satellite from the UE, or an elevation angle of the NTN satellite detected at the UE.

Example 13. The method of Example 11, wherein the resources can be preambles or random access channel occasions.

Example 14. The method of Example 13, wherein the preambles can include at least one physical random access channel (PRACH) preamble sequence.

Example 15. The method of Example 11, wherein each set of resources for Msg1 transmission can be associated with a geographic portion of a cell.

Example 16. The method of Example 11, wherein the UE can be a first UE, the method can further include detecting, by the base station, a second UE, in response to detecting the second UE, revising, by the base station, the Msg3 repetition request configuration set, and communicating, by the base station to the UE, the revised Msg3 repetition request configuration set.

Example 17. The method of Example 11, wherein the higher-layer signaling can be communicated using higher-layer signaling.

Example 18. A non-transitory computer-readable storage medium comprising instructions stored thereon that, when executed by at least one processor, are configured to cause a computing system to perform the method of any of Examples 1-17.

Example 19. An apparatus comprising means for performing the method of any of Examples 1-17.

Example 20. An apparatus comprising at least one processor and at least one memory including computer program code, the at least one memory and the computer program code configured to, with the at least one processor, cause the apparatus at least to perform the method of any of Examples 1-17.

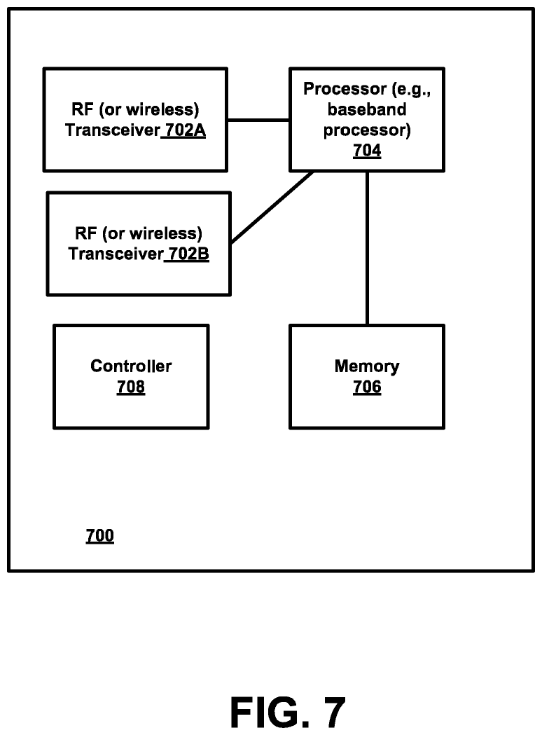

FIG. 7 is a block diagram of a wireless station 700 or wireless node or network node 700 according to an example embodiment. The wireless node or wireless station or network node 700 may include, e.g., one or more of an AP, BS, gNB, RAN node, relay node, UE or user device, network node, network entity, DU, CU-CP, CU-UP, . . . or other node) according to an example embodiment.

The wireless station 700 may include, for example, one or more (e.g., two as shown in FIG. 7) radio frequency (RF) or wireless transceivers 702A, 702B, where each wireless transceiver includes a transmitter to transmit signals and a receiver to receive signals. The wireless station also includes a processor or control unit/entity (controller) 704 to execute instructions or software and control transmission and receptions of signals, and a memory 706 to store data and/or instructions.

Processor 704 may also make decisions or determinations, generate frames, packets or messages for transmission, decode received frames or messages for further processing, and other tasks or functions described herein. Processor 704, which may be a baseband processor, for example, may generate messages, packets, frames or other signals for transmission via wireless transceiver 702 (702A or 702B). Processor 704 may control transmission of signals or messages over a wireless network, and may control the reception of signals or messages, etc., via a wireless network (e.g., after being down-converted by wireless transceiver 702, for example). Processor 704 may be programmable and capable of executing software or other instructions stored in memory or on other computer media to perform the various tasks and functions described above, such as one or more of the tasks or methods described above. Processor 704 may be (or may include), for example, hardware, programmable logic, a programmable processor that executes software or firmware, and/or any combination of these. Using other terminology, processor 704 and transceiver 702 together may be considered as a wireless transmitter/receiver system, for example.

In addition, referring to FIG. 7, a controller (or processor) 708 may execute software and instructions, and may provide overall control for the station 700, and may provide control for other systems not shown in FIG. 7, such as controlling input/output devices (e.g., display, keypad), and/or may execute software for one or more applications that may be provided on wireless station 700, such as, for example, an email program, audio/video applications, a word processor, a Voice over IP application, or other application or software.

In addition, a storage medium may be provided that includes stored instructions, which when executed by a controller or processor may result in the processor 704, or other controller or processor, performing one or more of the functions or tasks described above.

According to another example embodiment, RF or wireless transceiver(s) 702A/702B may receive signals or data and/or transmit or send signals or data. Processor 704 (and possibly transceivers 702A/702B) may control the RF or wireless transceiver 702A or 702B to receive, send, broadcast or transmit signals or data.

The example embodiments are not, however, restricted to the system that is given as an example, but a person skilled in the art may apply the solution to other communication systems. Another example of a suitable communications system is the 5G system. It is assumed that network architecture in 5G will be quite similar to that of the LTE-advanced. 5G is likely to use multiple input—multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labor between core network operations and base station operations may differ from that of the LTE or even be non-existent.

Example embodiments of the various techniques described herein may be implemented in digital electronic circuitry, or in computer hardware, firmware, software, or in combinations of them. Example embodiments may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, example embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Example embodiments may be implemented in a computing system that includes a back-end component, e.g., as a data server, or that includes a middleware component, e.g., an application server, or that includes a front-end component, e.g., a client computer having a graphical user interface or a Web browser through which a user can interact with an embodiment, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1-23. (canceled)

24. A user equipment (UE) comprising:
at least one processor; and
at least one memory including computer program code;
the at least one memory and the computer program code configured to, with the at least one processor, cause the UE to:
receive, by the UE, a Msg3 repetition request configuration set including a set of resources for Msg1 transmission;
determine, by the UE, a metric associated with a position of a non-terrestrial network (NTN) satellite with respect to the UE;
determine, by the UE, a subset of the set of resources for Msg1 transmission based on the metric;
determine, by the UE, whether a repetition request applies; and
in response to determining the repetition request applies, select, by the UE, a resource from the subset of the set of resources for Msg1 transmission.

25. The user equipment of claim 24, wherein the UE is caused to transmit the Msg1 based on the selected resource.

26. The user equipment of claim 24, wherein the Msg3 repetition request configuration set further includes a mapping between a range of the metric and a subset of the set of resources for Msg1 transmission.

27. The user equipment of claim 24, wherein the resources are preambles or random access channel occasions.

28. The user equipment of claim 24, wherein the metric is a distance to the NTN satellite from the UE, or an elevation angle of the NTN satellite detected at the UE.

29. The user equipment of claim 28, wherein the determining of the distance to the NTN satellite includes the UE configured to:
calculate the elevation angle of the NTN satellite, and
calculate the distance to the NTN satellite based on the elevation angle.

30. The user equipment of claim 29, wherein the distance to the NTN satellite is calculated as:
$$d = {R}_{e} [ \sqrt{{( \frac{h + {R}_{e}}{{R}_{e}} )}^{2}} - c o {s}^{2} φ - sin φ ] ,$$
where
d is the distance to the NTN satellite,
Rₑ is the radius of the Earth,
h is the NTN satellite altitude, and
φ is the UE elevation angle.

31. The user equipment of claim 24, wherein the UE is further configured to:
in response to determining the repetition request does not apply, the UE does not make a Msg3 repetition request.

32. The user equipment of claim 24, wherein the determining whether the repetition request applies is based on an SSB RSRP threshold.

33. The user equipment of claim 24, wherein the UE is a coverage enhanced (CE) UE.

34. A base station comprising:
at least one processor; and
at least one memory including computer program code;
the at least one memory and the computer program code configured to, with the at least one processor, cause the base station to:
configure, by the base station, a set of resources for Msg1 transmission;
map, by the base station, the set of resources for Msg1 transmission to a range associated with a metric associated with a position of the base station with respect to a user equipment (UE), the base station being included in a non-terrestrial network (NTN) satellite;
generate, by the base station, a Msg3 repetition request configuration set based on the set of resources for Msg1 transmission and the mapped range; and
communicate, by the base station to the UE, the Msg3 repetition request configuration set.

35. The base station of claim 34, wherein the metric is a distance to the NTN satellite from the UE, or an elevation angle of the NTN satellite detected at the UE.

36. The base station of claim 34, wherein the resources are preambles or random access channel occasions.

37. The base station of claim 36, wherein the preambles include at least one physical random access channel (PRACH) preamble sequence.

38. The base station of claim 34, wherein each set of resources for Msg1 transmission is associated with a geographic portion of a cell.

39. The base station of claim 34, wherein the UE is a first UE, the method comprising:
detecting, by the base station, a second UE;
in response to detecting the second UE, revising, by the base station, the Msg3 repetition request configuration set; and
communicating, by the base station to the UE, the revised Msg3 repetition request configuration set.

40. The base station of claim 34, wherein the higher-layer signaling is communicated using higher-layer signaling.
